(19) United States
(12) Patent Application Publication
(10) Pub. No.: US 2012/0082294 A1
(43) Pub. Date: Apr. 5, 2012

(54) X-RAY SYSTEM AND METHOD

(75) Inventors: Gary Virshup, Cupertino, CA (US); Robert Kluge, Sandy, UT (US); George A. Zdasiuk, Portola Valley, CA (US); Richard Colbeth, Los Altos, CA (US); Josh Star-Lack, Palo Alto, CA (US); Carl Lacasce, Park City, UT (US); James E. Clayton, San Jose, CA (US)

(73) Assignee: VARIAN MEDICAL SYSTEMS, INC., Palo Alto, CA (US)

(21) Appl. No.: 12/896,848

(22) Filed: Oct. 2, 2010

(51) Int. Cl. G01N 23/04

(52) U.S. Cl. 378/62

(57) ABSTRACT

An x-ray system includes an x-ray tube having an anode and a cathode, a sensor configured to sense a condition that results from an operation of the x-ray tube, and a communication device for transmitting a signal to a panel based at least in part on the sensed condition, the panel configured to receive radiation and generate image signals in response to the received radiation. An imaging method includes sensing a condition that results from an operation of an x-ray tube, and transmitting a signal to a panel in response to the sensed condition, wherein the panel is configured to generate image signals in response to radiation, and includes a plurality of image elements.

### FIELD

This invention relates to systems and methods for obtaining x-ray images.

### BACKGROUND

X-ray imaging device with an x-ray tube and a film is commonly used in many industries for generating x-rays, especially in the field of medical radiography. The existing practice is to place a patient between the x-ray tube and the film. An x-ray technician then positions the patient, sets up the x-ray device, and exposes the film using radiation from the x-ray device. The action of exposing the film is a two step process which uses a hand switch. In particular, the x-ray technician will press the hand switch button to a halfway position which (1) causes an anode inside the x-ray tube to spin up to a full speed, and (2) changes the state of a cathode inside the x-ray tube from a standby current to a calibrated preheat level. The preheat level is calibrated to be the required filament current to generate a prescribed beam current at a selected energy output by a power generator that is coupled to the x-ray tube.

When the x-ray tube and the power generator have stabilized, the technician will get a visual signal from the power generator that the tube is ready to generate x-ray for exposing the patient and the film. Since the film is always ready for receiving x-rays, the technician can then press the button fully, which activates the power generator to deliver energy to the tube, thereby generating x-rays as preprogrammed.

Digital x-ray imagers are replacing film to convert x-rays into images for many applications, including medical as well as industrial imaging. Applicants of the subject application determine that it will be desirable to have a new x-ray system and method for obtaining digital x-rays.

### SUMMARY

In accordance with some embodiments, an x-ray system includes an x-ray tube having an anode and a cathode, a sensor configured to detect an irradiance generated from an operation of the x-ray tube, and a communication device for transmitting a signal to a panel in response to the detected irradiance by the sensor. By means of non-limiting examples, the irradiance may be light, radiation, or other form of energy that radiates from a source.

In accordance with other embodiments, an x-ray system includes an x-ray tube having an anode and a cathode, a sensor configured to sense a condition that results from an operation of the x-ray tube, and a communication device for transmitting a signal to a panel based at least in part on the sensed condition, the panel configured to receive radiation and generate image signals in response to the received radiation.

In accordance with other embodiments, an imaging method includes sensing a condition that results from an operation of an x-ray tube, and transmitting a signal to a panel in response to the sensed condition, wherein the panel is configured to generate image signals in response to radiation, and includes a plurality of image elements.

Other and further aspects and features will be evident from reading the following detailed description of the embodiments, which are intended to illustrate, not limit, the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates an x-ray system in accordance with some embodiments;

FIG. 2 illustrates another x-ray system in accordance with other embodiments;

FIG. 3 illustrates another x-ray system in accordance with other embodiments;

FIG. 4 illustrates another x-ray system in accordance with other embodiments;

FIG. 5 illustrates another x-ray system in accordance with other embodiments;

FIG. 6 illustrates another x-ray system in accordance with other embodiments;

FIG. 7A illustrates a graph showing a relationship between photodetector signal and time;

FIG. 7B is a close up view of a portion of the graph of FIG. 7A;

FIG. 8A illustrates a graph showing a relationship between derivative of photodetector signal and time;

FIG. 8B is a close up view of a portion of the graph of FIG. 8A;

FIG. 9 illustrates an exposure sequence in accordance with some embodiments; and

FIG. 10 is a block diagram of a computer system architecture, with which embodiments described herein may be implemented.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

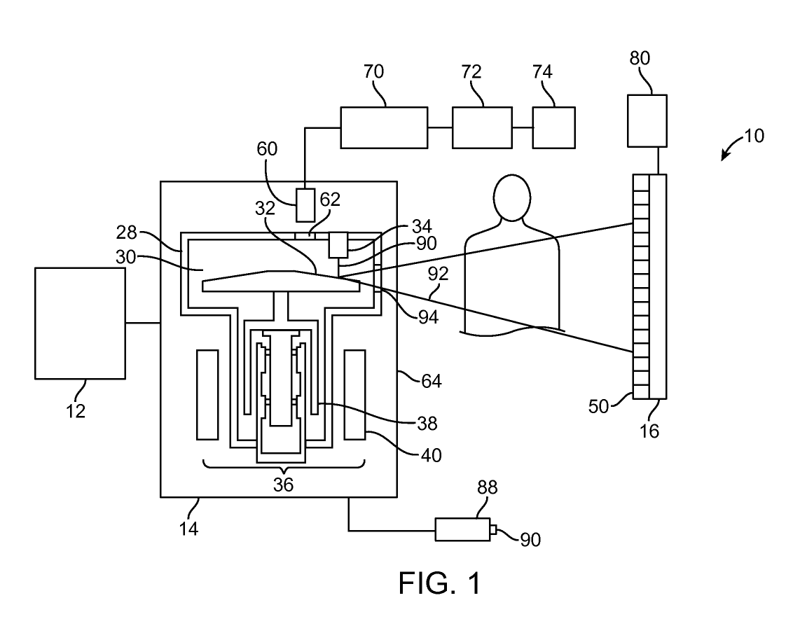

FIG. 1 illustrates an x-ray system 10 in accordance with some embodiments. The x-ray system 10 includes a power generator 12, an x-ray tube 14, and a panel 16. The power generator 12 is configured to provide power to the x-ray tube 14 during use of the x-ray system 10. The x-ray tube 14 includes a container 28 defining a chamber 30, an anode 32 and a cathode 34 located within the chamber 30, and a rotation device 36 for rotating the anode 32. The cathode 34 is configured to receive a voltage from the power generator 12 during use, and functions as an electron gun for delivering electrons towards the anode 32. The rotation device 36 includes a rotor 38 and a stator 40. The rotation device 36 is configured to rotate the anode 32 as electrons are accelerated from the cathode 34 towards the anode 32. Such configuration allows the electrons to hit different parts of the anode 32, thereby reducing an amount of heat that would otherwise be generated if the anode 32 is stationary.

In some embodiments, the anode material may be secured to a rotating disk that is coupled to the rotation device 36. In other embodiments, the anode 32 may be formed as part of the rotating disk. The target anode 32 can include a variety of materials that have suitable mechanical, thermal, electronic properties, and other suitable properties for production of prescribed x-ray spectra and intensity. Examples of materials that can be used includes holmium, erbium, lanthanum, cerium, praseodymium, neodymium, samarium, europium, terbium, dysprosium, thulium, ytterbium, lutetium, barium, molybdenum, rhodium, zirconium, hafnium, tungsten, titanium, rhenium, rhenium, molybdenum, copper, graphite, other rare earth materials and platinum group metals, and combination thereof. Suitably stable and refractory compounds, such as cerium boride (CeB₆), and other compounds formed from any of the above mentioned materials can be used for the anode 32.

The panel 16 includes a plurality of imaging elements 50. Each of the imaging elements 50 of the panel 16 is configured to receive radiation, and generate image signals in response to the received radiation. In some embodiments, the panel 16 includes a conversion layer made from a scintillator element, such as Cesium Iodide (CsI), and a photo detector array (e.g., a photodiode layer) coupled to a conversion layer. The conversion layer generates light photons in response to radiation, and the photo detector array, which includes a plurality of detector elements, is configured to generate electrical signal in response to the light photons from the conversion layer. The panel 16 can have a curvilinear surface (e.g., a partial circular arc). Such configuration is beneficial in that each of the imaging elements of the panel 16 is located substantially the same distance from the radiation source. In an alternative embodiment, the panel 16 may have a rectilinear surface or a surface having other profiles. The panel 16 can be made from amorphous silicon, crystal and silicon wafers, crystal and silicon substrate, or flexible substrate (e.g., plastic), and may be constructed using flat panel technologies or other techniques known in the art of making imaging device. In alternative embodiments, the panel 16 may use different detection schemes. For example, in alternative embodiments, instead of having the conversion layer, the panel 16 may include a photoconductor, which generates electron-hole-pairs or charges in response to radiation.

In the illustrated embodiments, the x-ray system 10 also includes a photodetector (sensor) 60 coupled to the x-ray tube 14. The photodetector 60 is configured to detect light generated from an activation of the cathode 34. As shown in the figure, the container 28 includes an opening 62 that allows the light generated from activation of the cathode 34 to exit therethrough, so that the light can be detected by the photodetector 60. In some embodiments, the container 28 may be made from glass, thereby providing more options for placement of the photodetector 60. The photodetector 60 and the container 28 are located within an x-ray tube housing 64. In other embodiments, the container 28 may be a part of, or an extension of, the x-ray tube housing 64. Also, in further embodiments, the photodetector 60 may not be completely inside the x-ray tube housing 64. Instead, the photodector 60 may be extend partially through a wall of the x-ray tube housing 64, or may be located outside the x-ray tube housing 64 (in which case, the x-ray tube housing 64 may include an opening for allowing light generated from the activation of the cathode 34 to exit therethrough).

It should be noted that as used in this specification, the term “photodetector” may refer to any sensor that can detect irradiance (such as light, radiation, heat, etc.), or that can detect any feature associated with an irradiance. The sensor 60 may be implemented using different technologies in different embodiments. For example, the sensor 60 may be implemented using Silicon, GaAs, aSi, CdTe, or any of other photodiodes. In other embodiments, thermal pile(s) may be used to implement the sensor 60. In further embodiments, voltage output or a current output of a photodiode may be used to generate an output by the sensor 60. In other embodiments, the sensor may be a current sensor coupled to a current lead that transmits a current to the cathode 34.

The x-ray system 10 also includes an A/D converter 70 coupled to the photodetector 60, conditioning electronics 72, and a signal transmitter 74. The A/D converter 70 is configured to convert signal(s) from the photodetector 60 to a digital form. The conditioning electronics 72 is configured to receive signal(s) from the ND converter 70, process the signal(s) according to a predetermined logic/algorithm, and generate an output signal based on the processing of the signal(s) from the ND converter 70. The conditioning electronics 72 may be implemented using hardware, software, or combination of hardware and software. For example, in some embodiments, the conditioning electronics 72 may be implemented using a processor, a computer, or other device that has signal processing capability. The transmitter 74 is configured to transmit the output signal to a receiver 80 that is coupled to the panel 16. The panel 16 is configured to, in response to the signal received by the receiver 80, reset the image elements 50, perform integration of signals to generate image signals, and readout the image signals. By means of non-limiting examples, each of the transmitter 74 and the receiver 80 may be a radiofrequency device, an infrared device, an ultrasonic device, or a Bluetooth device. In further embodiments, the transmitter 74 and the receiver 80 may be implemented using one or more wires, or one or more optical fibers, that connect from the conditioning electronics 72 to the panel 16.

In the illustrated embodiments, the components 60, 70, 72, 74 are illustrated as separate components. However, in other embodiments, the ND converter 70 may be a part of the sensor 60. In further embodiments, the ND converter 70 and the conditioning electronics 72 are parts of the sensor 60. Also, in other embodiments, the conditioning electronics 72 may be a part of the panel 16, or a component that is physically coupled to the panel 16.

The x-ray system 10 also includes a hand-held control 88 with a control button 90 that is operatively coupled to the x-ray tube 14. The control 88 is configured to operate the x-ray tube 14 during use. In particular, the button 90 of the control 88 may be pressed half-way to cause the rotation device 36 to spin the anode 32. After the anode 32 has been spun to a desired speed, the button 90 of the control 88 may then be pressed fully to cause electrons to accelerate from the cathode 34 to the anode 32.

During use of the x-ray system 10, the generator 12 supplies an initial current to the cathode 34 to warm up the cathode 34, which brings the cathode 34 into a “standby” mode. Next, the control button 90 may be pressed half-way to cause the anode 32 to spin, and to cause the generator 12 to deliver additional current to the cathode 34 so that the cathode 34 is in a “ready-to-fire” mode. The additional current causes the temperature of the cathode 34 to rise from a warmed-up (or standby) level to a pre-calibrated level. The operator may further actuate the button 90 to fully press the button 90. In the illustrated embodiments, the fully-pressing of the control button 90 causes the voltage generator 12 to supply an activation current to the cathode 34, resulting in electrons being accelerated from the cathode 34 to the spinning target anode 32. In particular, due to a potential that is generated between the cathode 34 and the anode 32, the electrons accelerate towards the anode 32, forming a beam 90 of electrons. The beam 90 can be a continuous beam, or alternatively, a pulsed beam. X-rays are generated by the interaction of the electron beam 90 and the anode 32. Most of the generated x-rays are confined by the container 28 and/or the x-ray tube housing 64, while a beam 92 of the x-ray escapes from an x-ray window 94. In the illustrated embodiments, the anode 32 has a ring or circular configuration. As x-rays are generated, the rotation device 36 rotates the anode 32 such that the electron beam 90 impinges on different locations on the anode 32, thereby preventing the anode 32 from being overheated.

In the illustrated embodiments, the activation of the cathode 34 is sensed by the sensor 60, which transmits a signal to the conditioning electronics 72. When the conditioning electronics 72 receives the signal from the sensor 60, the conditioning electronics 72 then transmit a control signal via the device 74 to the panel 16, to thereby control an operation of the panel 16. In the illustrated embodiments, the control signal is used to cause the panel 16 to reset its imaging elements 50. However, it should be noted that as used in this specification, the term “control signal” is not limited to a signal that is for directly controlling an operation of the panel 16, and that it may refer to any information that is used in any process for operating the panel 16. Also, as used in this specification, the act of controlling an operation of the panel 16 is not limited to the physical act of operating the panel 16, and may include providing information that is used in any process for operating the panel 16.

In one implementation, the conditioning electronics 72 is configured to determine if the signal from the sensor 60 is at or above a prescribed threshold (which may be associated with an activation of the cathode 34), and if the signal is at or above the prescribed threshold, then the conditioning electronics 72 then transmit the control signal to the panel 16. In the illustrated embodiments, the panel 16 is configured to reset the imaging elements 50 after a prescribed period since the sensing of the condition by the photodetector 60. In other embodiments, the panel 16 is configured to reset the imaging elements 50 after a prescribed period has lapsed since the panel 16 receives the signal from the conditioning electronics 72. In further embodiments, the conditioning electronics 72 may be a part of the panel 16, in which case, the panel 16 is configured to reset the imaging elements 50 after a prescribed period has lapsed since the conditioning electronics 72 generates a signal. In any of the embodiments described herein, the prescribed period may be at least 100 milliseconds, or other values, such as any value between 0 to 0.5 seconds. In any of the embodiments described herein, the panel 16 is informed of the impending x-ray at least 0.35 second before the impending x-ray happens. This allows the panel 16 to have sufficient time to reset the image elements 50. In further embodiments, the imaging elements 50 are reset as soon as the panel 16 receives a signal from the conditioning electronics 72 without waiting for any prescribed period.

In some embodiments, after the panel 16 has reset its imaging elements 50, the panel 16 is also configured to perform signal integration to obtain the image signals, and read out the image signals. The panel 16 may be configured to perform the signal integration based on a fixed integration period, or a variable integration period. In some embodiments, the variable integration period may be based on the sensed condition by the sensor 60. In some embodiments, the panel 16 may include a processor for determining the variable integration period based on the sensed condition(s). For example, in some embodiments, the sensor 60 can send a signal that the x-ray's are ON and then again that they are OFF. Then the panel can respond by ending the integration period early, and can record the actual integration time used in terms of it's internal clock frequency, by counting clock periods. Then panel can acquire an offset image (dark image) with the same integration period and use that offset image to correct the x-ray image.

It should be noted that the configuration (e.g., shapes, dimensions, designs, and arrangements of various components) of the x-ray system 10 should not be limited to the example illustrated in the figure, and that the x-ray system 10 can have other configurations. For example, in other embodiments, the x-ray system 10 may have a different shape.

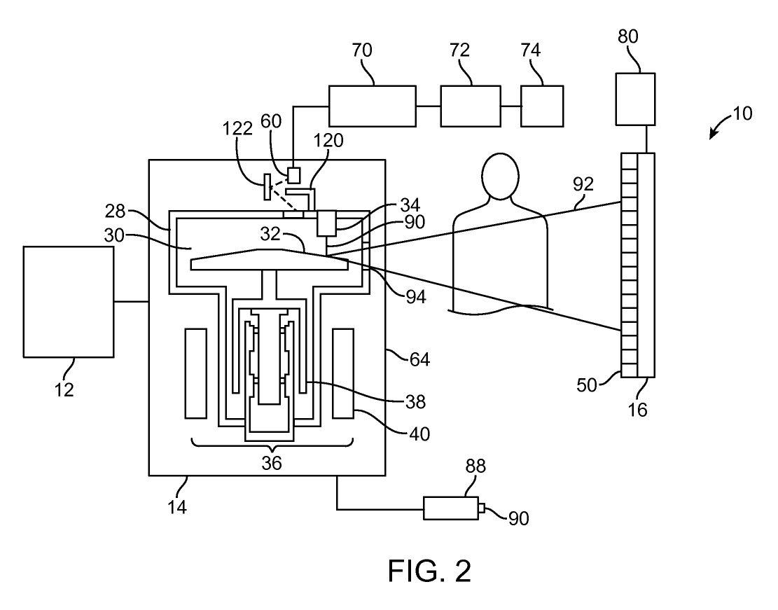

In other embodiments, the x-ray system 10 may optionally further include a shield 120, and a mirror 122 (FIG. 2). The shield 120 is for blocking radiation towards the photodetector 60 to protect the photodetector 60 from being damaged by the radiation, and the mirror 122 is for reflecting the light towards the photodetector 60. The mirror 122 may have a rectilinear or a curvilinear configuration. The operation of the x-ray system 10 of FIG. 2 is similar to that described with reference to the embodiments of FIG. 1.

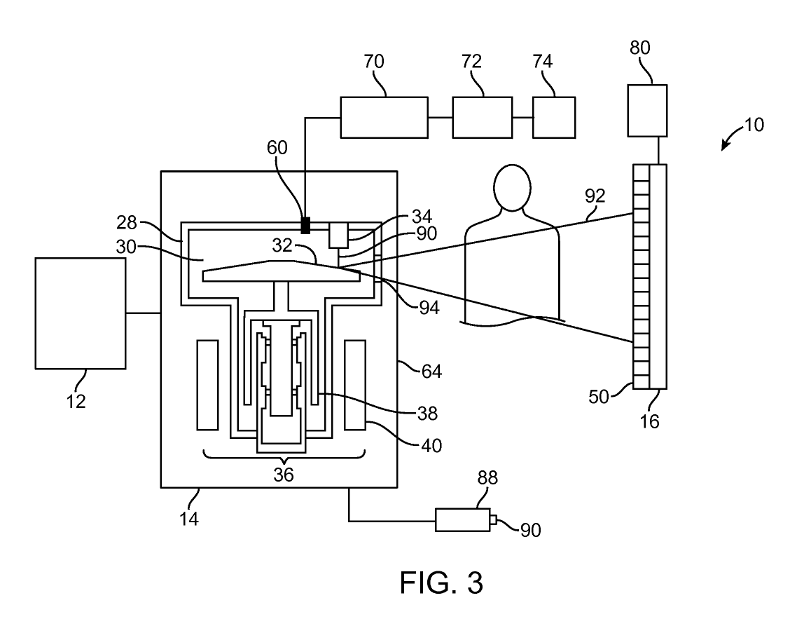

FIG. 3 illustrates another x-ray system 10 in accordance with other embodiments. The x-ray system 10 of FIG. 3 is similar to the embodiments of FIG. 1, except that the photodetector 60 is not located outside the container 28. Instead, the photodetector 60 is located at least partially within the container 28. Such configuration allows the photodetector 60 to more efficiently detect light that is generated from the operation of the cathode 34. The operation of the x-ray system 10 of FIG. 3 is similar to that described with reference to the embodiments of FIG. 1.

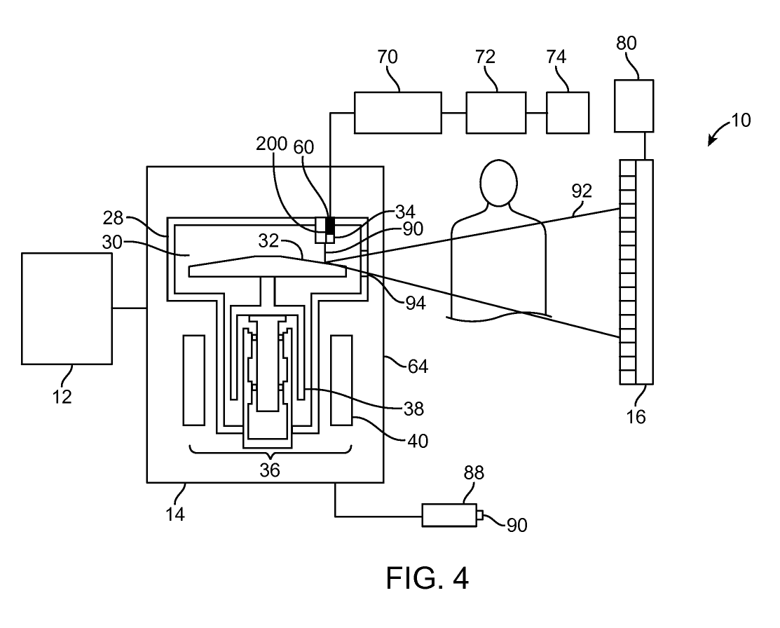

FIG. 4 illustrates another x-ray system 10 in accordance with other embodiments. The x-ray system 10 of FIG. 4 is similar to the embodiments of FIG. 1, except that the photodetector 60 is located in a shaft 200 of the cathode 34. Such configuration obviates the need to create a separate opening through the wall of the housing 28 for allowing detection of the light by the photodetector 60. Also, because the photodetector 60 is located within the shaft 200 of the cathode, it has less chance of being deteriorated by radiation that is generated within the chamber 30. In other embodiments, the photodetector 60 may be located at other locations. For example, in other embodiments, the shaft 200 of the cathode 34 may include a fiber optic for transmitting light from within the chamber 30 to another location where the photodetector 60 is located. The photodetector 60 receives the light signal from the fiber optic, and generates a signal (for transmission to component 70, 72, and/or 74) based on the light signal received from the fiber optic. In other embodiments, both the photodetector 60 and the fiber optic may be located within the shaft of the cathode 34. In further embodiments, the fiber optic and/or the photodetector 60 may be located at other places relative to the tube housing 64 as long as the photodetector 60 can sense light that is generated from an operation of the tube 14. The operation of the x-ray system 10 of FIG. 4 is similar to that described with reference to the embodiments of FIG. 1.

In any of the embodiments described herein, instead of using a photodetector, the system 10 can include another type of sensor. For example, in any of the embodiments described herein, instead of being a photodetector, the sensor 60 may be a heat sensor, or another type of sensor that is configured to sense a condition associated with the activation of the cathode 34, such as any device that senses an attribute or a physical change in the cathode (e.g., temperature, photon emission, current, voltage, magnetic field, light, etc.).

In any of the embodiments described herein, instead of light, the photodetector 60 may be configured to detect radiation that is generated from an operation of the x-ray tube (e.g., radiation emitted from operating any of the components of the x-ray tube).

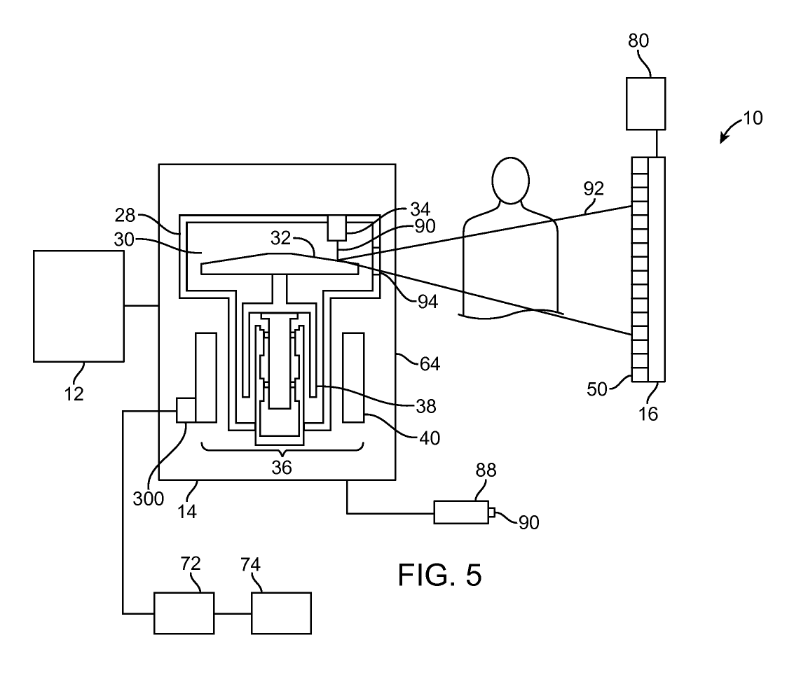

FIG. 5 illustrates another x-ray system 10 in accordance with other embodiments. The x-ray system 10 does not include the photodetector 60. Instead, the x-ray system 10 includes a current detector/sensor 300 configured to detect a current associated with an operation of the rotation device 36. During use of the x-ray system 10 of FIG. 5, the generator 12 supplies an initial current to the cathode 34 to warm up the cathode 34, which brings the cathode 34 into a “standby” mode. Next, the control button 90 may be pressed half-way to cause the anode 32 to spin, and to cause the generator 12 to deliver additional current to the cathode 34 so that the cathode 34 is in a “ready-to-fire” mode. The additional current causes the temperature of the cathode 34 to rise from a warmed-up (or standby) level to a pre-calibrated level. The operator may further actuate the button 90 to fully press the button 90. In the illustrated embodiments, the fully-pressing of the control button 90 causes the voltage generator 12 to supply an activation current to the cathode 34, resulting in electrons being accelerated from the cathode 34 to the spinning target anode 32. In particular, due to a potential that is generated between the cathode 34 and the anode 32, the electrons accelerate towards the anode 32, forming a beam 90 of electrons. The beam 90 can be a continuous beam, or alternatively, a pulsed beam. X-rays are generated by the interaction of the electron beam 90 and the anode 32. Most of the generated x-rays are confined by the container 28 and/or the x-ray tube housing 64, while a beam 92 of the x-ray escapes from an x-ray window 94. In the illustrated embodiments, the anode 32 has a ring or circular configuration. As x-rays are generated, the rotation device 36 rotates the anode 32 such that the electron beam 90 impinges on different locations on the anode 32, thereby preventing the anode 32 from being overheated.

In the illustrated embodiments of FIG. 5, the rotation of the anode 32 is sensed by the sensor 300, which transmits a signal to the conditioning electronics 72. In one implementation, AC currents of different phases may be applied to different windings of the stator 40. In such case, the start of rotation will cause an increase in the current in the stator leads, which can be used to indicate imminent exposure. When the conditioning electronics 72 receives the signal from the sensor 300, the conditioning electronics 72 then transmit a control signal via the device 74 to the panel 16, thereby causing the panel 16 to reset its imaging elements 50. In one implementation, the conditioning electronics 72 is configured to determine if the signal from the sensor 300 is at or above a prescribed threshold (which may be associated with a full/or a minimal operational rotating speed of the anode 32), and if the signal is at or above the prescribed threshold, then the conditioning electronics 72 then transmit the control signal to the panel 16. In the illustrated embodiments, the panel 16 is configured to reset the imaging elements 50 after a prescribed period since the sensing of the condition by the sensor 300. In other embodiments, the panel 16 is configured to reset the imaging elements 50 after a prescribed period has lapsed since the panel 16 receives the signal from the conditioning electronics 72. In further embodiments, the conditioning electronics 72 may be a part of the panel 16, in which case, the panel 16 is configured to reset the imaging elements 50 after a prescribed period has lapsed since the conditioning electronics 72 generates a signal. In any of the embodiments described herein, the prescribed period may be at least 100 milliseconds, or other values, such as any value between 0 to 0.5 seconds.

In some embodiments, after the panel 16 has reset its imaging elements 50, the panel 16 is also configured to perform signal integration to obtain the image signals, and read out the image signals. The panel 16 may be configured to perform the signal integration based on a fixed integration period, or a variable integration period. In some embodiments, the variable integration period may be based on the sensed condition by the sensor 300. In some embodiments, the panel 16 may include a processor for determining the variable integration period based on the sensed condition(s), as similarly discussed.

In other embodiments, instead of using a current detector, a magnetic sensor may be used to pickup on the rotor speed. In such cases, when the speed of the rotor stabilizes, then the conditioning electronics 72 will inform the panel 16 that exposure is imminent.

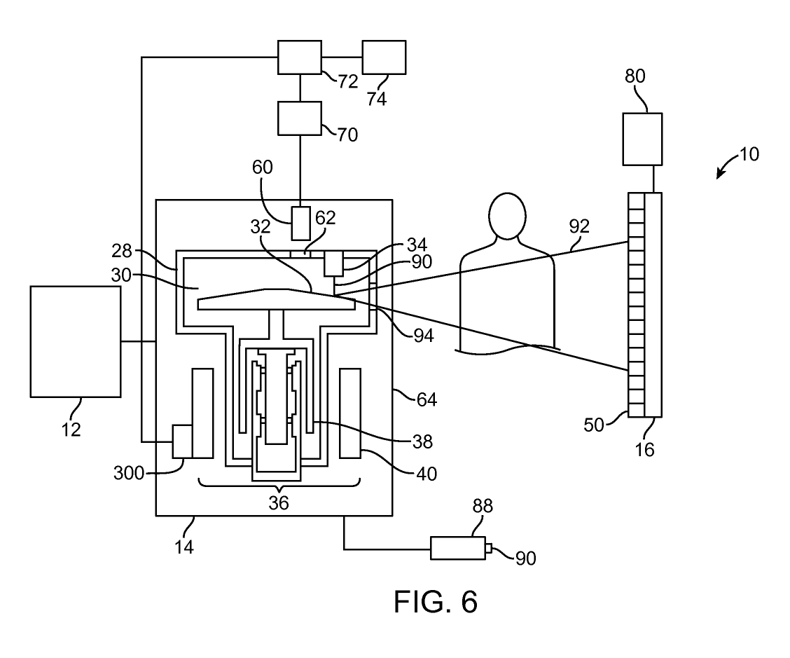

In further embodiments, two or more features of the above embodiments may be combined. For example, in further embodiments, the x-ray system 10 may include both the sensor 60 (which may be a photodetector, a heat sensor, or any other sensor configured to sense a condition associated with an operation of the cathode 34, etc.), and the current detector 300. FIG. 6 illustrates another x-ray system 10 in accordance with other embodiments. As shown in the figure, the x-ray system 10 includes the photodetector 60 (which is similarly discussed with reference to FIG. 1) and the current detector 300 (which is similar discussed with reference to FIG. 5). During use, the generator 12 may supply an initial current to the cathode 34 to warm up the cathode 34, which brings the cathode 34 into a “standby” mode. Next, the control button 90 may be pressed half-way to cause the anode 32 to spin. The current detector 300 is configured to sense a current associated with the operation of the rotation device 36, and transmit a first signal to the conditioning electronics 72. The pressing of the button 90 to the half-way position also causes a current to be transmitted to the cathode 34, causing its temperature to rise from the warmed-up level to a pre-calibrated level, so that the cathode 34 is in the “ready-to-fire” state. The sensor 60 is configured to sense a condition associated with the emission state of the cathode, and transmit a second signal representing the sensed condition to the conditioning electronics 72. In the illustrated embodiments, the fully-pressing of the control button 90 causes the voltage generator 12 to supply an activation current to the cathode 34, resulting in electrons being accelerated from the cathode 34 to the spinning target anode 32.

When the conditioning electronics 72 receives the first signal from the current sensor 300, and/or the second signal from the sensor 60, the conditioning electronics 72 then transmit a control signal via the device 74 to the panel 16, thereby causing the panel 16 to reset its imaging elements 50. In some embodiments, after the panel 16 has reset its imaging elements 50, the panel 16 is also configured to perform signal integration to obtain the image signals, and read out the image signals. The panel 16 may be configured to perform the signal integration based on a fixed integration period, or a variable integration period. In some embodiments, the variable integration period may be based on the sensed condition by the sensor 60, the sensed condition by the sensor 300, or both sensed conditions by the sensors 60, 300, respectively. In some embodiments, the panel 16 may include a processor for determining the variable integration period based on the sensed condition(s), as similarly described previously. Other features described in the previous embodiments may be implemented in the embodiments of FIG. 6.

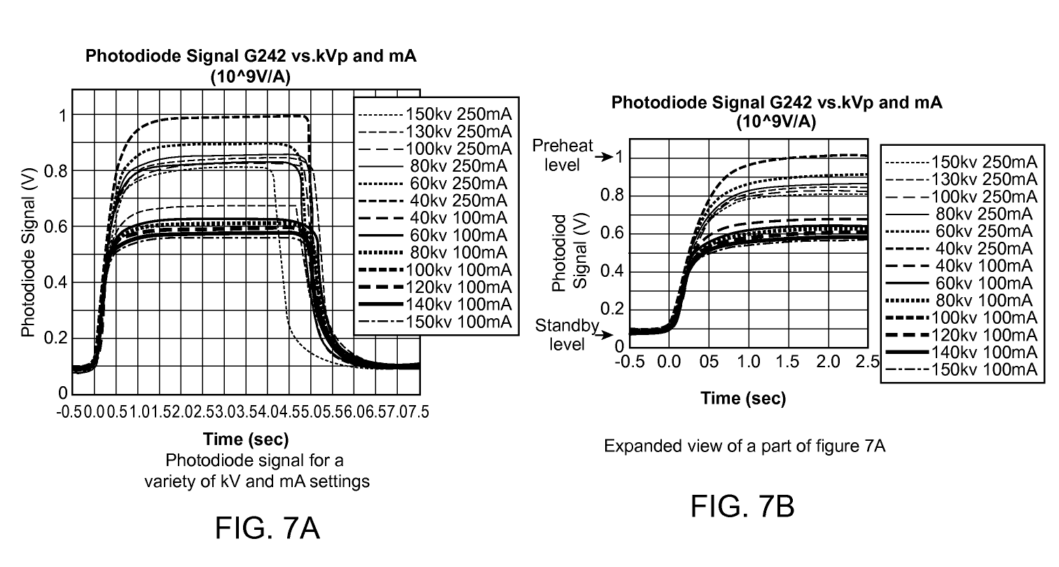

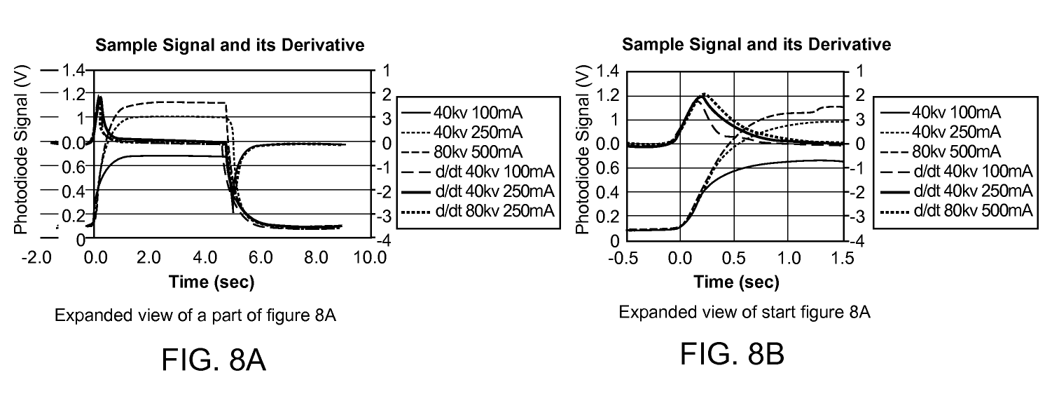

FIG. 7A illustrates a graph of data collected using an embodiment of a x-ray tube 10. The graph shows the values of signals seen by the photodetector 60 as the current being delivered to the cathode 34 is increased from a standby level to a preheat level. When the cathode filament goes from a standby state to a preheat state, the temperature of the filament is increased by a significant amount because the filament is used as a source of electrons, and the release of electrons from the filament of the cathode 34 is exponentially temperature dependent. The irradiance from the filament is proportional to T⁴. As shown in the figure, the signals seen by the photodetector 60 are stable after approximately 1.5 seconds. FIG. 7B is a close up of the first few seconds after the control button 90 of the x-ray tube 10 is pressed half-way, and shows that all the signals are substantially the same for the first 250 milliseconds, and then they differentiate due to their final values. The different values (e.g., peak voltage kVp applied to the tube, beam current mA, exposure time, etc.) are pre-programmed into the x-ray system 10 (e.g., in the conditioning electronics 72) using a calibration procedure. In general, at a given mA of a beam current, as the kV energy level from the generator 12 is increased, there is a lower required filament current and thus photodetector signal. Also, at a constant kVp, the filament current increases with increasing mA. FIG. 8A shows some of the selected photodetector signals from FIG. 7A, and derivatives of those signals. The derivatives show a sharp positive peak at the start of the increase in filament current, and a sharp negative peak as the filament current returns from the preheat values to standby values. FIG. 8B is a close up of the first few seconds after the control button 90 of the x-ray tube 10 is pressed half-way. The profile of the curve(s) shown may be used to determine impending x-ray. For example, in the non-derivative case, the system may be configured to apply a threshold crossing detector to see when the filament current has gone up and then come down. In such technique, the signal size will depend on the kVp and mA chosen, which varies by the body part they are imaging. In other embodiments, the derivative of the signal may be used, which has the advantage that the peak value does not depend on kVp and mA as much. This allows the system to operate more reliably. In some embodiments, the conditioning electronics 72 may include a smoothing filter, a signal derivative, or other processing to remove spurious signals, and prepare a signal to be transmitted to the control electronics of the panel 16.

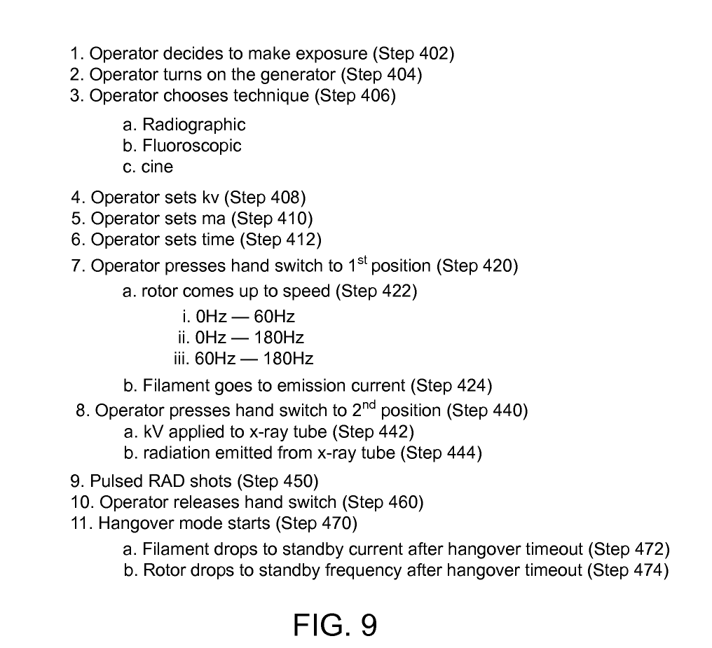

FIG. 9 illustrates an exposure method 400 that may be performed using any of the embodiments of the x-ray system 10 in accordance with some embodiments. Once the operator has decided to make an exposure (step 402), the operator then turns on the generator 12 (step 404). The generator 12 then sends a stand-by current (e.g., 2 amps) to the cathode (or filament) 34 to warm up the cathode 34. The operator may choose one of the imaging techniques, including radiographic imaging, fluoroscopic imaging, and cine imaging (which is higher dose fluoroscopic imaging that is used to record a video sequence for later analysis) (Step 406). The operator then sets the energy level of the generator 12 (step 408), sets mA for the beam current (step 410), and sets time for the radiation pulse (step 412). In some cases, the time for the pulse is set by the operator on the console, depending on the body part being imaged. The beam pulse length is part of what defines the imaging technique, along with kVp (energy), and mA (tube current).

Next, the operator then presses the button 90 of the control 88 to a first position (e.g., half-pressed position) (Step 420). In response to the pressing of the button 90 to the first position, the anode 32 starts spinning (step 422), and an emission current is delivered to the cathode (filament) 34 (step 424). In one implementation, the emission current is delivered by increasing the current being delivered to the cathode 34 from the standby current to a preheat current (e.g., 4-6 amps). As discussed previously with reference to FIG. 7A, as emission current is being delivered to the cathode 34, the signal seen by sensor 60 increases and then stabilizes. The speed of the anode 32 rotation may be anywhere between 3600 to 9000 rpm, or another value. In some embodiments, the system is configured to allow the operator to select the speed range of the rotor 38 that corresponds with the half-activation of the button 90. For example, in some embodiments, the system may allow the operator to set the speed range to be 0 Hz-60 Hz, in which case, when the button 90 is half-activated, the rotor speed will increase from 0 Hz to 60 Hz. In other embodiments, the speed range of the rotor 38 may be 0 Hz-180 Hz, 60 Hz-180 Hz, or other ranges.

The operator then presses the button 90 to a second position (e.g., the fully-pressed position) (step 440). In response to the pressing of the button 90 to the second position, the generator 12 then applies energy to the x-ray tube 14 (step 442), resulting in radiation being emitted from the x-ray tube (step 444). In the illustrated embodiments, the energy has an energy level that is set by the operator in step 406.

As shown in the figure, Pulsed Rad shots may optionally be provided (step 450). “Rad” shots are pulsed, since the beam is only ON for a finite duration of time. The time for the pulse is set by the operator on the console, depending on the body part being imaged. The beam pulse length is part of what defines the imaging technique, which involves parameters such as kVp (energy), mA (tube current), and time. In some cases, the number of mAs (milliamp-seconds) used to create the beam pulse may be used to indicate delivered dose. In some embodiments, the pulsed rad shots may be provided in 30 fps over 1 to 5 seconds.

The operator then releases the control button 90 (step 460), which causes a hangover mode to begin (step 470). In the hangover mode, the current of the cathode 34 is allowed to go back to the standby current after a prescribed hangover time (step 472), and the rotor 38 is allowed to go back to a standby frequency (which may be 0 Hz, 60 Hz, or other value) after the prescribed hangover time (step 474). The hangover time may be a value selected by the operator. In some embodiments, the system 10 provides a user interface for allowing the operator to select such hangover time, which may be any value from 0-99 seconds, for example. During the hangover time, the cathode 34 and the rotor 38 remain in a “ready-to-fire” state so that the operator can make an additional image (exposure) by fully-activating the button 90. After the hangover time (i.e., after the system 10 exits the hangover mode), if the operator wishes to make an additional image, then steps 420-444 will be repeated.

As illustrated in the above embodiments, the system 10 is advantageous in that it allows the panel 16 to know of an imminent x-ray, and therefore, the panel 16 can automatically reset the image elements 50 at the appropriate timing so that integration of signals when no radiation is applied can be minimized or at least reduced. The system 10 is also advantageous in that there is no need to modify the generator 12 in order to implement features described herein. Thus, existing generators 12 may be used with embodiments of the system 10 described herein.

As illustrated in the above embodiments, the half activation state of the control 88 allows the panel 16 to get ready and to wait in integration mode. However, in some situations, the operator may press the control button 90 half way, and may wait for a long time before fully actuating the button 90. In such situations, the sensing by the sensor 60 and/or the current sensor 300 may not accurately correlate with the eminent emission of x-ray (because the actual emission will only happen if the user fully presses the control button 90). Also, if the user waits for a long period between half-actuation and full-actuation, then the imaging elements 50 may be reset too early.

To address the above issues, in some embodiments, the panel 16 may be configured to be in integration mode for no longer than a prescribed period. For example, in some embodiments, the panel 16 may be in integration mode for no more than 10 seconds between half-way activation and full activation of the button 90. In such example, if the operator waits for four seconds between half-way activation and full activation, then the panel 16 will be in integration mode for those four seconds in which it receives no radiation. However, when the operator fully activates the button 90 within the next six seconds, radiation will be delivered, and the panel 16 will integrate image signals generated as a result of the radiation. In other embodiments, the operator may be required to wait no longer than a prescribed period between half-way activation and full activation of the button 90. The above techniques prevent the panel from staying in integration for a long period of time, which accumulates a lot of dark current, reduces the dynamic range of the panel 16, and creates artifacts. Also, the above techniques are advantageous in that they accommodate a very wide range of activation times between half-activation and full-activation of the control button 90.

In other embodiments, the panel 16 may be configured so that it is constantly integrating and reading out signals. For example, the panel 16 may include amorphous silicon PIN photodiode/TFT type arrays, which are capable of continuously integrating signal. In one implementation, the panel 16 may be configured to readout every one second (or another prescribed period) and sum the frames with dose in them. In such embodiments, the panel 16 reads out the data every one second, even when there is no radiation (i.e., even when the control button 90 is not fully pressed). For example, if the operator waits for four seconds between half activation and full activation, the panel 16 will still read out data in those four seconds in which there is no radiation. In such cases, the read out from the four seconds would not be used (in other words, the summing of frames would include those that are resulted from radiation only).

In other embodiments, the panel 16 may be configured to operate at a continuous, constant frame rate. For this general scenario it is assumed that we are using a panel with is no resetting required (i.e. PIN/TFT array). In this case, there is no dead time and no advance notice is required by the panel to operate the panel 16. During use, the panel 16 uses the signal from sensor 60 (or any of the sensor described herein) to determine which frames have dose in them, and add only those frames together. So for example, the moment sensor (e.g., sensor 60) sends “x-rays ON”, the panel starts to sum (accumulate) frames in it's internal memory or in another memory. When the panel sees “x-rays OFF”, it finishes that last frame, stops the accumulation and transmits the image (which is accumulated from a number of frames) to a non-transitory memory for storage or to a screen for display. Alternatively the summing could happen in a workstation. In such cases, the panel may create a flag in the image data to indicate that the frame has dose in it. Later, at a workstation, a processor may be configured to select all frames that have a flag, and sum those frames to create an accumulated dose image.

In still other embodiments, the panel 16 may provide a reset feature that is so fast that only a small percentage of the applied dose is lost. For example, in some embodiments, the panel 16 may be reset in 100 ms or less. In other embodiments, the panel 16 may be reset in 10 ms or less. In any of the embodiments, the signal from the radiation beam itself may be used to trigger the reset and transition to integration.

In further embodiments, a sensor may be used to detect full activation of the control button 90. In such cases, the panel will be in integration mode when (1) the cathode is fully heated up, (2) the anode achieves full speed, and (3) the user control button 90 is fully pressed. Such technique may allow eminent emission of x-ray to be accurately correlated with the full actuation of the control button 90.

In the above embodiments, the system 10 has been described as having a rotating anode. In any of the embodiments described herein, the anode may alternatively be stationary. In such cases, the system 10 does not include any device for rotating the anode.

Also, the sensor for sensing an operation of the tube 14 is not limited to the examples described previously. In other embodiments, the tube 14 may include other types of sensors for sensing other conditions that are associated with the operation of the tube 14. For example, in other embodiments, the tube 14 may include a vibration sensor for sensing a vibration that may occur when the tube 14 is activated. In other embodiments, the tube 14 may include a sound sensor for sensing sound that results from an operation of the tube 14. In still other embodiments, a motion sensor may be used to sense a motion of a mechanical component at the tube 14. In further embodiments, the tube 14 may include a sensor for sensing an electron beam that is created at the tube 14, or that is being emitted from the tube 14. In such cases, the detected electron beam would indicate imminent x-ray being delivered to the panel 16. In still further embodiments, the tube 14 may include a sensor for sensing a current (e.g., a large current that is above a prescribed level) that is being delivered to the cathode 34 or a current at the cathode 34. In such cases, the detected current would indicate imminent x-ray being delivered to the panel 16. Other types of sensors may also be used in other embodiments.

Furthermore, in any of the embodiments described herein, the signal(s) for controlling the operation of the panel 16 does not need to be transmitted directly from the tube (e.g., from the sensor at the tube) to the panel 16.

Instead, the signal(s) may be transmitted to the panel 16 indirectly though an intermediate device.

Computer System Architecture

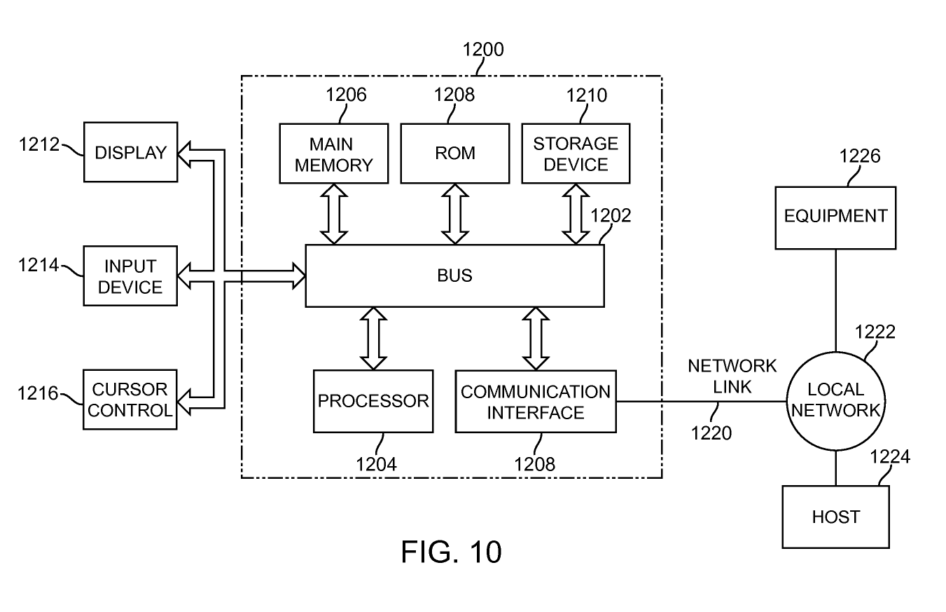

FIG. 10 is a block diagram that illustrates an embodiment of a computer system 1200 upon which an embodiment of the invention may be implemented. Computer system 1200 includes a bus 1202 or other communication mechanism for communicating information, and a processor 1204 coupled with the bus 1202 for processing information. The processor 1204 may be an example of the conditioning circuits 72, or another processor that is used to perform various functions described herein. In some cases, the computer system 1200 may be used to implement the conditioning circuits 72. The computer system 1200 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution of instructions to be executed by the processor 1204. The computer system 1200 further includes a read only memory (ROM) 1208 or other static storage device coupled to the bus 1202 for storing static information and instructions for the processor 1204. A data storage device 1210, such as a magnetic disk or optical disk, is provided and coupled to the bus 1202 for storing information and instructions.

The computer system 1200 may be coupled via the bus 1202 to a display 1212, such as a cathode ray tube (CRT) or a flat panel, for displaying information to a user. An input device 1214, including alphanumeric and other keys, is coupled to the bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

The computer system 1200 may be used for performing various functions (e.g., calculation) in accordance with the embodiments described herein. According to one embodiment, such use is provided by computer system 1200 in response to processor 1204 executing one or more sequences of one or more instructions contained in the main memory 1206. Such instructions may be read into the main memory 1206 from another computer-readable medium, such as storage device 1210. Execution of the sequences of instructions contained in the main memory 1206 causes the processor 1204 to perform the process steps described herein. One or more processors in a multi-processing arrangement may also be employed to execute the sequences of instructions contained in the main memory 1206. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 1204 for execution. Such a medium may take many forms, including but not limited to, non-volatile media, volatile media, and transmission media. Non-volatile media includes, for example, optical or magnetic disks, such as the storage device 1210. Non-volatile medium may be considered as an example of a non-transitory medium. Volatile media includes dynamic memory, such as the main memory 1206. Volatile medium may be considered as another example of a non-transitory medium. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the computer system 1200 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received by the main memory 1206 may optionally be stored on the storage device 1210 either before or after execution by the processor 1204.

The computer system 1200 also includes a communication interface 1218 coupled to the bus 1202. The communication interface 1218 provides a two-way data communication coupling to a network link 1220 that is connected to a local network 1222. For example, the communication interface 1218 may be an integrated services digital network (ISDN) card or a modem to provide a data communication connection to a corresponding type of telephone line. As another example, the communication interface 1218 may be a local area network (LAN) card to provide a data communication connection to a compatible LAN. Wireless links may also be implemented. In any such implementation, the communication interface 1218 sends and receives electrical, electromagnetic or optical signals that carry data streams representing various types of information.

The network link 1220 typically provides data communication through one or more networks to other devices. For example, the network link 1220 may provide a connection through local network 1222 to a host computer 1224 or to equipment 1226 such as a radiation beam source or a switch operatively coupled to a radiation beam source. The data streams transported over the network link 1220 can comprise electrical, electromagnetic or optical signals. The signals through the various networks and the signals on the network link 1220 and through the communication interface 1218, which carry data to and from the computer system 1200, are exemplary forms of carrier waves transporting the information. The computer system 1200 can send messages and receive data, including program code, through the network(s), the network link 1220, and the communication interface 1218.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. For example, the term “processor” may include one or more processing units, and may refer to any device that is capable of performing mathematical computation implemented using hardware and/or software. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. An x-ray system, comprising:
an x-ray tube having an anode and a cathode;
a sensor configured to detect an irradiance generated from an operation of the x-ray tube; and
a communication device for transmitting a signal to a panel in response to the detected irradiance by the sensor.

2. The x-ray system of claim 1, wherein the sensor is configured to detect the irradiance that is generated from an activation of the cathode.

3. The x-ray system of claim 1, wherein the x-ray tube comprises a chamber for housing the anode and the cathode, and wherein the sensor is located within the chamber.

4. The x-ray system of claim 1, wherein the x-ray tube comprises a chamber for housing the anode and the cathode, and wherein the sensor is located outside the chamber.

5. The x-ray system of claim 4, wherein the chamber comprises a window for allowing the irradiance to transmit from within the chamber to the sensor.

6. The x-ray system of claim 1, further comprising a circuit for determining whether the detected irradiance is above a prescribed threshold.

7. The x-ray system of claim 1, wherein the signal is for causing the panel to reset image elements of the panel, perform signal integration to obtain image signals, and read out the image signals.

8. The x-ray system of claim 7, wherein the signal is for causing the panel to perform the signal integration based on a fixed integration period.

9. The x-ray system of claim 7, wherein the signal is for causing the panel to perform the signal integration based on a variable integration period.

10. The x-ray system of claim 9, further comprising a circuit for determining the variable integration period based on a signal generated by the sensor.

11. The x-ray system of claim 1, further comprising the panel, wherein the panel comprises image elements, and is configured to reset the image elements after the signal is received for a prescribed period.

12. The x-ray system of claim 11, wherein the prescribed period is at least 100 milliseconds.

13. The x-ray system of claim 1, wherein the irradiance comprises light, and the system further comprises a shield for blocking radiation towards the sensor, and a mirror for reflecting the light towards the sensor.

14. The x-ray system of claim 1, further comprising:
a shaft for holding the cathode; and
a fiber optic;
wherein the sensor is coupled to the fiber optic, and one or both of the sensor and the fiber optic is located within the shaft.

15. The x-ray system of claim 1, wherein the communication device comprises a wire, a RF transmitter, an infrared device, an ultrasonic device, an optical fiber, or a Bluetooth device.

16. The x-ray system of claim 1, further comprising a device for rotating the anode.

17. The x-ray system of claim 1, wherein the panel is configured to receive radiation and generate image signals in response to the received radiation.

18. An x-ray system, comprising:
an x-ray tube having an anode and a cathode;
a sensor configured to sense a condition that results from an operation of the x-ray tube; and
a communication device for transmitting a signal to a panel based at least in part on the sensed condition, the panel configured to receive radiation and generate image signals in response to the received radiation.

19. The x-ray system of claim 18, wherein the sensor comprises a photodetector configured to detect an irradiance that is generated from an activation of the cathode.

20. The x-ray system of claim 18, wherein the sensor comprises a heat sensor for sensing heat that is generated from an activation of the cathode.

21. The x-ray system of claim 18, wherein the sensor comprises a current sensor coupled to a current lead, wherein the current lead is configured to transmit a current to the cathode.

22. The x-ray system of claim 18, wherein the sensor comprises a current sensor for sensing a current being delivered to a rotating device that is configured to rotate the anode.

23. The x-ray system of claim 18, wherein the sensor comprises a magnetic sensor.

24. The x-ray system of claim 18, further comprising a circuit for determining whether a variable associated with the sensed condition is above a prescribed threshold.

25. The x-ray system of claim 18, wherein the signal is for causing the panel to reset image elements of the panel, perform signal integration to obtain the image signals, and read out the image signals.

26. The x-ray system of claim 25, wherein the signal is for causing the panel to perform the signal integration based on a fixed integration period.

27. The x-ray system of claim 25, wherein the signal is for causing the panel to perform the signal integration based on a variable integration period.

28. The x-ray system of claim 27, further comprising a circuit for determining the variable integration period based on the sensed condition.

29. The x-ray system of claim 18, further comprising the panel, wherein the panel has image elements, and is configured to reset the image elements after a prescribed period has lapsed since the transmission of the signal or since the condition is sensed.

30. The x-ray system of claim 29, wherein the prescribed period is at least 100 milliseconds.

31. The x-ray system of claim 18, wherein the communication device comprises a wire, a RF transmitter, an infrared device, an ultrasonic device, an optical fiber, or a Bluetooth device.

32. An imaging method, comprising:
sensing a condition that results from an operation of an x-ray tube; and
transmitting a signal to a panel in response to the sensed condition, wherein the panel is configured to generate image signals in response to radiation, and includes a plurality of image elements.

33. The imaging method of claim 32, wherein the signal is for causing the panel to reset the image elements.

34. The imaging method of claim 33, wherein the signal is for causing the panel to reset the image elements after a prescribed period has lapsed since the transmission of the signal or since the condition is sensed.

35. The imaging method of claim 34, wherein the prescribed period is at least 100 milliseconds.

36. The imaging method of claim 34, wherein the signal is for causing the panel to integrate signals to generate the image signals, and to read out the image signals.

37. The imaging method of claim 32, further comprising determining a variable integration period based on the sensed condition.

38. The imaging method of claim 32, wherein the sensed condition comprises light that is generated from an activation of a cathode, radiation that is generated from an activation of a cathode, heat that is generated from an activation of the cathode, current being transmitted to the cathode, current being delivered to a rotating device, or a magnetic field.

39. The imaging method of claim 32, further comprising determining whether a variable associated with the sensed condition is above a prescribed threshold.
